(19) United States
(12) Patent Application Publication
(10) Pub. No.: US 2016/0117693 A1
(43) Pub. Date: Apr. 28, 2016

(54) DIGITAL MATURITY ASSESSMENT FOR TRANSPORTATION PROVIDERS

(71) Applicant: NIIT Technologies Ltd, New Delhi (IN)

(72) Inventors: ANIL BATRA, New Delhi (IN); JIVESH BAHADUR, New Delhi (IN); PUNEET SACHDEV, New Delhi (IN); RATAN KUMAR, New Delhi (IN); UDAYAN BANERJEE, New Delhi (IN)

(21) Appl. No.: 14/918,612

(22) Filed: Oct. 21, 2015

(30) Foreign Application Priority Data
Oct. 22, 2014 (IN) 3021/DEL/2014

(51) Int. Cl. G06Q 30/02; G06F 17/30

(52) U.S. Cl. CPC G06Q 30/0201; G06F 17/30528; G06F 17/30958

(57) ABSTRACT

An aspect of the present disclosure facilitates the assessment of the digital maturity of a transport provider. In one embodiment, data indicating availability of engagement capabilities on respective digital channels of the transport provider is received, and scores representing digital maturity of the transport provider are computed based on the availability. The engagement capabilities may be categorized according to functional areas qualifying an industry of the transport provider, and as such the scores may correspond to respective functional areas. Thus, the transport provider is enabled to compare the engagement capabilities of his/her organization with those of other providers or with pre-defined standards.

### PRIORITY CLAIM

The instant patent application is related to and claims priority from the co-pending provisional India patent application entitled, “DIGITAL MATURITY ASSESSMENT FRAMEWORK FOR AN AIRLINE”, Serial No.: 3021/DEL/2014, Filed: 22 Oct. 2014, which is incorporated in its entirety herewith to the extent not inconsistent with the disclosure herein.

### BACKGROUND OF THE DISCLOSURE

1. Technical Field

The present disclosure relates to transport management systems and more specifically to digital maturity assessment for transportation providers.

2. Related Art

Transportation providers' transport or move people (travelers) and goods (cargo) between various locations. Thus persons who are travelers, senders/receivers of goods, the agents facilitating transportation by ticketing, etc., are all considered customers of the transportation provider. Airlines, railways and bus lines are common examples of such transportation providers, though the description below is provided substantially with respect to airlines.

Customers often engage with airlines through various digital channels. A digital channel may be viewed as a platform enabling customers to engage with the airline based on digital data streams. There can be any number of digital channels, with each digital channel providing distinct user experience and/or engagement capabilities to the customers. Examples of such digital channels thus include online/web channel, mobile channel, social media channel, in-flight entertainment (IFE) channel, kiosks channel, etc.

The inventors have found a need to provide assessment of digital maturity of various airlines (or transportation providers, in general). The assessment generally needs to reflect the various engagement capabilities provided by the airlines using various digital channels. Aspects of the present disclosure facilitate digital maturity assessment for transportation providers.

### BRIEF DESCRIPTION OF THE DRAWINGS

Example embodiments of the present disclosure will be described with reference to the accompanying drawings briefly described below.

FIG. 1 is a block diagram illustrating an example environment (computing system) in which several aspects of the present invention can be implemented.

FIG. 2 is a flow chart illustrating the manner in which digital maturity assessment for a transportation provider (airline) is performed according to an aspect of the present disclosure.

FIG. 3 is a block diagram illustrating the manner in which engagement capabilities of various digital channels are classified in one embodiment.

FIGS. 4A-4D illustrates the manner in which availability of engagement capabilities of digital channels is assessed in one embodiment.

FIGS. 5A and 5B depict the manner in which scores representing digital maturity of a transport provider (airline) is displayed in one embodiment.

FIG. 6 is a block diagram illustrating the details of a digital processing system in which various aspects of the present disclosure are operative by execution of appropriate executable modules.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE EMBODIMENTS OF THE DISCLOSURE

### 1. Overview

An aspect of the present disclosure facilitates the assessment of the digital maturity of a transport provider. In one embodiment, data indicating availability of engagement capabilities on respective digital channels of the transport provider is received, and scores representing digital maturity of the transport provider are computed based on the availability. Thus, in an embodiment, a higher score indicates a higher level of maturity reflecting the availability of more engagement capabilities over the digital channels provided by the transportation provider.

According to another aspect of the present disclosure, the engagement capabilities may be categorized according to functional areas qualifying an industry of the transport provider, and as such the scores may correspond to respective functional areas. Thus, the transport provider is enabled to compare the engagement capabilities of his/her organization with those of other providers or with pre-defined standards.

According to further aspect of the present disclosure, the functional areas are further grouped into different assessment verticals. A respective questionnaire for each of the assessment verticals is provided, with a questionnaire for an assessment vertical containing questions directed to determining the availability of the engagement capabilities in the functional areas grouped into the assessment vertical. As such, the answers to the questions in the questionnaires corresponding to the assessment verticals constitute the received data (noted above).

In one embodiment, a respective radar graph for each assessment vertical is displayed, with the functional areas grouped into an assessment vertical represented as corresponding axes of the radar graph for the assessment vertical and the (computed) scores for each of the functional areas plotted along the corresponding axes.

Several aspects of the present disclosure are described below with reference to examples for illustration. However, one skilled in the relevant art will recognize that the disclosure can be practiced without one or more of the specific details or with other methods, components, materials and so forth. In other instances, well-known structures, materials, or operations are not shown in detail to avoid obscuring the features of the disclosure. Furthermore, the features/aspects described can be practiced in various combinations, though only some of the combinations are described herein for conciseness.

### 2. Example Environment

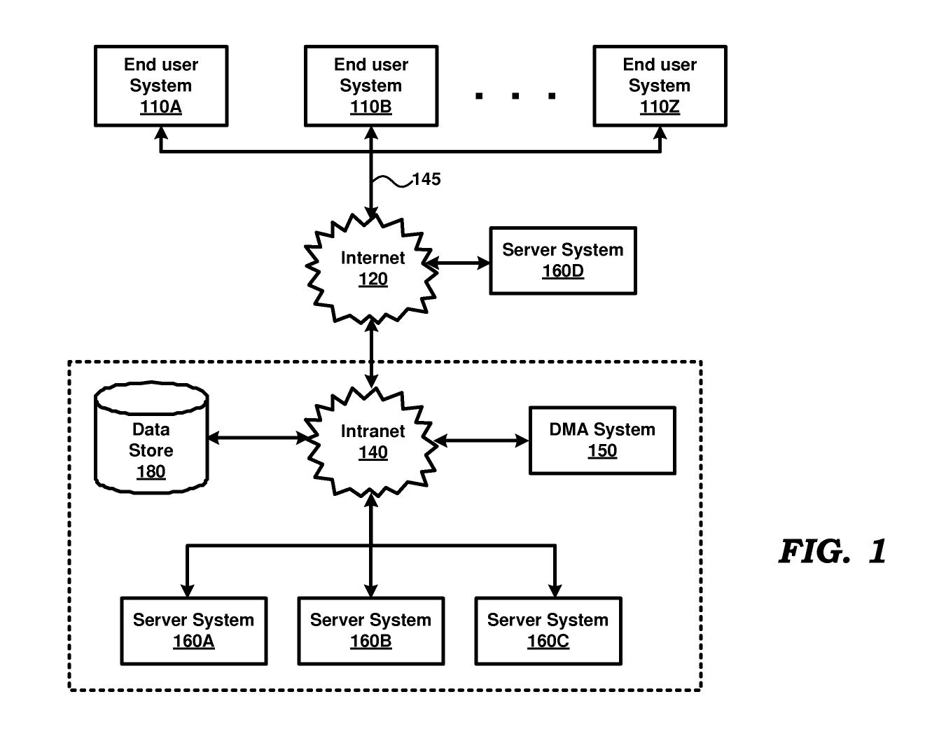

FIG. 1 is a block diagram illustrating an example environment (computing system) in which several aspects of the present invention can be implemented. The computing system is shown containing network 110, data store 120, digital maturity assessment (DMA) system 150 and end user systems 160A-160X.

FIG. 1 is a block diagram illustrating an example environment (computing system) in which several aspects of the present invention can be implemented. In one embodiment, the computing system of FIG. 1 is provided by an airline (transportation provider) for engaging with customers over multiple digital channels. The block diagram is shown containing end user systems 110A-110Z, Internet 120, intranet 140, server systems 160A-160D, DMA system 150 and data store 180.

Merely for illustration, only representative number/type of systems is shown in FIG. 1. Many environments often contain many more systems, both in number and type, depending on the purpose for which the environment is designed. Each block of FIG. 1 is described below in further detail.

Intranet 140 represents a network providing connectivity between server systems 160A-160C, data store 180, and DMA system 150, all provided within an enterprise or domain (shown with dotted boundaries) of the airline. Internet 120 extends the connectivity of these (and other systems of the enterprise) with external systems such as end user systems 110A-110Z. Each of intranet 140 and Internet 120 may be implemented using protocols such as Transmission Control Protocol (TCP) and/or Internet Protocol (IP), well known in the relevant arts.

In general, in TCP/IP environments, a TCP/IP packet is used as a basic unit of transport, with the source address being set to the TCP/IP address assigned to the source system from which the packet originates and the destination address set to the TCP/IP address of the target system to which the packet is to be eventually delivered. An IP packet is said to be directed to a target system when the destination IP address of the packet is set to the IP address of the target system, such that the packet is eventually delivered to the target system by intranet 140 and Internet 120.

Data store 180 represents a non-volatile (persistent) storage facilitating storage and retrieval of a collection of data by applications executing in server systems 160A-160C (and also DMA system 150). Data store 180 may be implemented as a database server using relational database technologies and accordingly provide storage and retrieval of data using structured queries such as SQL (Structured Query Language). Alternatively, data store 180 may be implemented as a file server providing storage and retrieval of data in the form of files organized as one or more directories, as is well known in the relevant arts.

Each of end user systems 110A-110Z represents a system such as a personal computer, workstation, mobile device, tablets, etc., used by users (customers of the airline) to generate (client) requests directed to applications executing in server systems 160A-160D. In the case of an airline enterprise, an end user system may also represent a in-flight entertainment (IFE) console, kiosk, etc. or any end user device which provides a user interface for a digital channel. The client requests may be generated using appropriate user interfaces (e.g., web pages provided by an application executing in a server system, a native user interface provided by a portion of the application downloaded from the server system, etc.). In general, a client system requests an application for performing desired tasks and receives corresponding responses containing the results of performance of the requested tasks. Each client request is sent in the form of an IP packet directed to the desired server system (and application), with the IP packet including data identifying the desired tasks in the payload portion.

Each of server systems 160A-160D represents a server, such as a web/application server, executing (server) applications capable of performing tasks requested by customers using one of end user systems 110A-110Z. A server system may use data stored internally (for example, in a non-volatile storage/hard disk within the server system), external data (e.g., maintained in data store 180) and/or data received from external sources (e.g., from the user) in performing the requested tasks. The server system then sends the result of performance of the tasks to the requesting end user system (one of 110A-110Z). The results may be accompanied by specific user interfaces (e.g., web pages) for displaying the results to the requesting user.

It may be observed that some of the server systems (such as 160A-160C) are shown internal to the enterprise (within the dotted boundary), while other server systems (such as 160D) are shown external to the enterprise. The airline uploads the digital data to such external server systems (160D), which in turn streams the uploaded data, to the customers of the airline using end user systems 110A-110Z. Examples of external server systems are social network servers, video/image sharing servers, etc.

It may be appreciated that the data transferred on path 145 can be the basis for various digital channels made available to customers at end user systems 110A-110Z. For example, when an end user system is a mobile/tablet type device (and the digital data is typically made available via native mobile applications), the channel is referred to as a mobile channel. Similarly, when an end user system is a kiosk or IFE console, the corresponding channel is referred to as kiosk channel or IFE channel respectively. When the digital data is streamed (from server systems 160A-160C) and the interaction of a customer is via a browser application, the channel is referred to as an online/web channel. However, when the user engages with the airline using social media such as Facebook, Twitter, etc., provided via server system 160D, the channel is referred to as social media channel (irrespective of whether a native/browser application is used for such engagement).

It may be desirable for the airline to assess the digital maturity of the engagement between the customers and the airline over the various digital channels (path 145). For example, the airline may wish to change customer behavior and/or the digital channels of engagement, in view of the customers being connected to other customers/competitive airlines and sharing her/her experiences with others over Internet 120. Further, airlines industry is continuously impacted by new standards (such as NDC (“New Distribution Capability”) from IATA, OTA from Open Travel Alliance, Open Axis, etc.) that present opportunities to save cost and increase revenue for an airline. In addition, ancillary revenues are fast becoming a significant portion of any airline's revenue and hence the airline may wish to assess the digital maturity to identify opportunities to generate such ancillary revenues.

Digital maturity assessment (DMA) system 150, provided according to several aspects of the present disclosure, facilitates the digital maturity assessment for airlines (and transportation providers, in general) as described below with examples.

### 3. Assessing Digital Maturity of a Transportation Provider

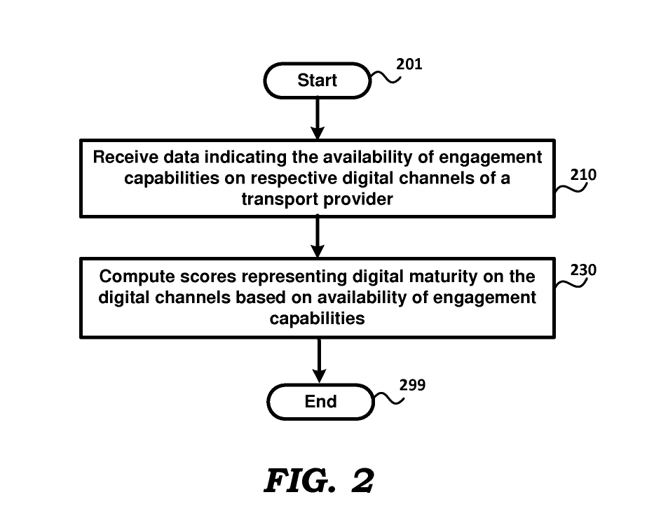

FIG. 2 is a flow chart illustrating the manner in which digital maturity assessment for a transportation provider (airline) is performed according to an aspect of the present disclosure. The flowchart is described with respect to DMA system 150 of FIG. 1 merely for illustration. However, many of the features can be implemented in other environments also without departing from the scope and spirit of several aspects of the present invention, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present invention. The flow chart begins in step 201, in which control immediately passes to step 210.

In step 210, DMA system 150 receives data indicating the availability of engagement capabilities on respective digital channels of an airline/transport provider. An engagement capability of a digital channel refers to a specific type/form of interaction that a customer is facilitated to perform on that digital channel. The availability indicates whether an engagement capability on respective digital channels is present (corresponding interaction is facilitated for the customers) or absent (no such interaction is possible). Each digital channel may have different engagement capabilities based on the digital data streams forming the digital channel, the user interfaces provided to the customers, the hardware/software of the end user systems on which the user interfaces are provided, etc.

The availability of the engagement capabilities may be received as inputs from users (personnel of the airline) using user interfaces provided by DMA system 150. Alternatively, the inputs from the users may be stored in data store 180, and at a later time instance, retrieved from data store 180 (for example, in response to a digital maturity assessment request received from an administrator using DMA system 150).

In step 230, DMA system 150 computes scores representing digital maturity on the digital channels based on availability of engagement capabilities. Each score indicates the extent of interactions possible between customers and the airline/transportation provider over a corresponding digital channel. The flow chart ends in step 299.

By comparing the computed scores with the respective scores for other transportation providers/airlines or with pre-defined standards, personnel of the airline can identify potential ways to modify customer behavior and/or the digital channels, save cost and increase revenues based on new industry standards (noted above), and also to generate ancillary revenues.

The manner in which DMA system 150 performs digital maturity assessment for an airline (whose computing system is shown in FIG. 1) according to FIG. 2 is illustrated below with examples.

### 4. Illustrative Example

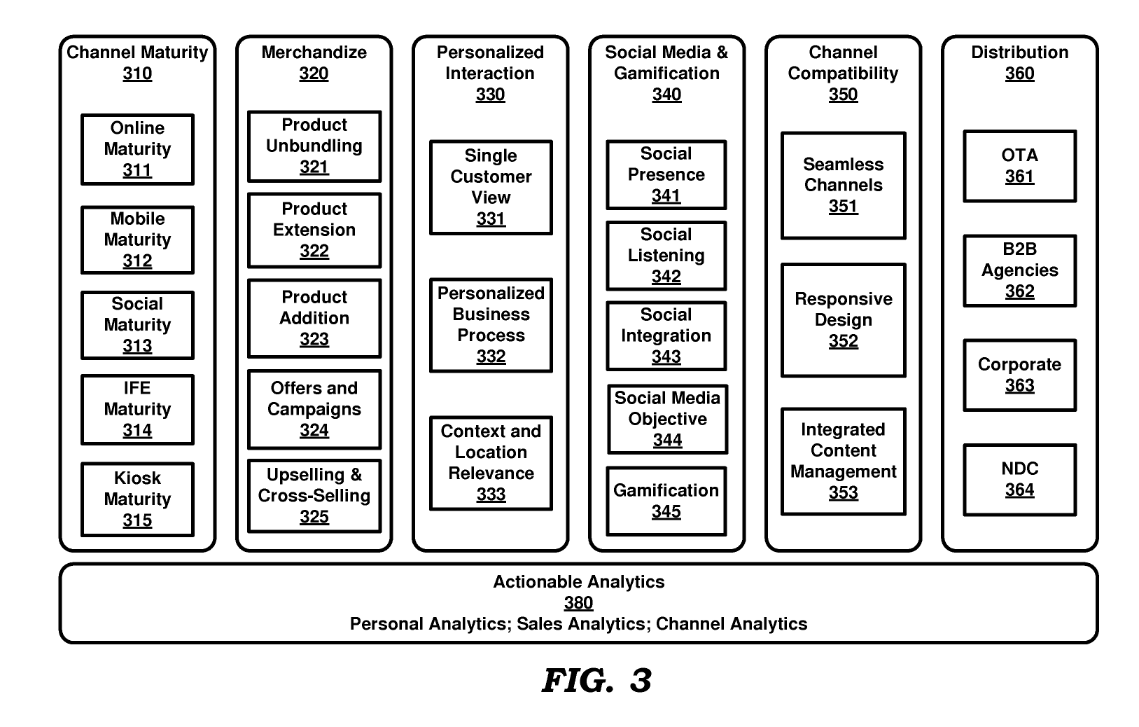

FIGS. 3, 4A-4D and 5A-5B together illustrate the manner in which digital maturity assessment is performed for an airline in one embodiment. Each of the Figures is described in detail below.

FIG. 3 is a block diagram illustrating the manner in which engagement capabilities of various digital channels are classified in one embodiment. Broadly, the engagement capabilities are categorized into various functional areas qualifying the industry of the transport provider, here the airline industry. The functional areas in turn are further grouped into different assessment verticals.

In FIG. 3, each of Channel Maturity 310, Merchandize 320, Personalized Interaction 330, Social Media & Gamification 340, Channel Compatibility 350 and Distribution 360 represents an assessment vertical, with each assessment vertical shown containing a corresponding set/group of functional areas (such as online maturity 311, social listening 342, corporate 363, etc.). A brief description of each of the assessment verticals and functional areas shown in FIG. 3 is provided below.

Channel Maturity 310 compares relative maturity of various channels with weightage and relevance for various engagement capabilities. Online maturity 311 refers to assessing the capability to sell and service customers through the Airline's primary digital channel on the web (that is, Internet 120). Mobile Maturity 312 refers to assessing the capability to sell and service customers using their mobile devices while accessing (either using native mobile applications or mobile websites) the Airline's sales and services platform. Social Maturity 313 assesses how mature the Airline in on social networks (e.g., Facebook™, Twitter™, LinkedIn™, etc.) and media sharing websites (e.g., Youtube™, etc.) through which customers interact with the Airline. IFE Maturity 314 assesses how mature the In-flight Entertainment System related interaction is between the customers and the Airline. Kiosk Maturity 315 assesses the maturity of the interaction between the Airline and customer using Airline/airport kiosk systems.

Merchandize 320 assesses product unbundling, extension, addition and campaign management capabilities of the Airline. Product Unbundling 321 refers to assessing the capability to split the traditional airline seats into various newer products like seats, meals, baggage etc. Product Extension 322 refers to assessing the capability to enhance the existing products by developing newer versions of the same, such as paid priority boarding being an extension of business class priority boarding service, real time notification of baggage being an extension of baggage service, etc. Product Addition 323 refers to assessing the ability to add new products and ancillaries. Offers & Campaigns 324 refers to assessing the ability to create offers and run campaigns by the Airline. Upselling and Cross-selling 325 refers to assessing the capability to offer upgrades to higher value products and be able to sell other non-airline products.

Personalized Interaction 330 assesses how the Airline leverages the customer data that it holds to provide a personalized experience and business processes to its customers. Single Customer View 331 refers to assessing the ability to offer a single view of customer profile, score, preferences and history with the Airline. Personalized Business Processes 332 refers to assessing the ability to personalize business processes across all customer touch points based on customer data. Context and Location Relevance 333 refers to assessing the contextual relevance of information and ability to offer relevant information to the customer at all stages of customer journey

Social Media & Gamification 340 assesses how an airline integrates with social media in order to further its cause. Social Presence 341 refers to assessing the presence of the Airline across various social networks and how vibrant and fresh that presence management is. Social Listening 342 refers to assessing the ability of the Airline to listen to the social buzz generated around its brand, the ability to respond to feedback in near real time as well as attempt to do service recovery where possible. The intent is to prevent negative feedback from going viral, as well as promote positive feedback to go viral. Social Integration 343 refers to assessing the ability to integrate various application platforms with social media and data. Examples of this are social login, assisted registrations, enriching user profile with social media and social applications. Social Media Objective 344 refers to assessing whether the objectives of the Airline with respect to social media (social networks and media sharing websites) are being met. Gamification 345 refers to assessing the ability to increase and sustain customer engagement through multiple channels by using game mechanics and incentivizing certain site actions which are helpful to the business of the Airline

Channel Compatibility 350 assesses how well integrated are several of the digital channels of the Airline. Seamless Channels 351 refers to assessing the ability for customer to switch seamlessly between various digital channels without losing any information. E.g. Perform search on mobile and complete the booking on web channel. Responsive Design 352 refers to assessing the capability of airline online platform to provide optimal viewing experience with minimal need for resizing, panning, and scrolling across a wide range of devices. Integrated Content Management 353 refers to assessing the capability to offer central hosting and publishing of content to various digital channels in a seamless manner. Such a feature ensures that same information is distributed to the customer, no matter which digital channel the customer is currently using.

Distribution 360 assesses how the Airline uses various distribution channels at its disposal for distributing its inventory. OTA 361 refers to assessing the ability to leverage Online Travel Agencies (OTAs) and better distribute through OTAs. B2B Agencies 362 refers to assessing the ability to better distribute through B2B network. Corporate 363 refers to assessing the ability to distribute and service the corporate sector. NDC 364 refers to assessing the capability to implement NDC to better distribute the Airline's inventories and increase revenues using newer technologies and other such industry initiatives.

In addition to the various assessment verticals, FIG. 3 is shown containing Actionable Analytics 380 which assesses how the Airline makes use of Analytics in the area of customer interaction, sales and digital channels. Personal Analytics refers to assessing the capability to perform analytics related to customer journey, and where customer tends to exit the interaction with the Airline/brand. Sales Analytics refers to assessing the ability to perform analytics related to the sales for the brand Channel Analytics refers to assessing the ability to perform analytics of the channel specific interactions of the consumers.

Thus, the various engagement capabilities of different digital channels are classified into functional areas and assessment verticals. In one embodiment, scores are computed for each functional area, with the scores of the functional areas in a single assessment vertical provided/displayed together.

According to an aspect of the present disclosure, the assessment of the availability of the various engagement capabilities is performed by providing a respective questionnaire for each of the assessment verticals (310, 320, 330, 340, 350 and 360). A questionnaire for an assessment vertical contains questions directed to determining the availability of the engagement capabilities in the functional areas grouped into the assessment vertical. The data (of step 210) accordingly contains the answers to the questions in the various questionnaires. Some sample questionnaires that may be provided for assessment of the digital maturity is described in detail below.

### 5. Sample Questionnaires

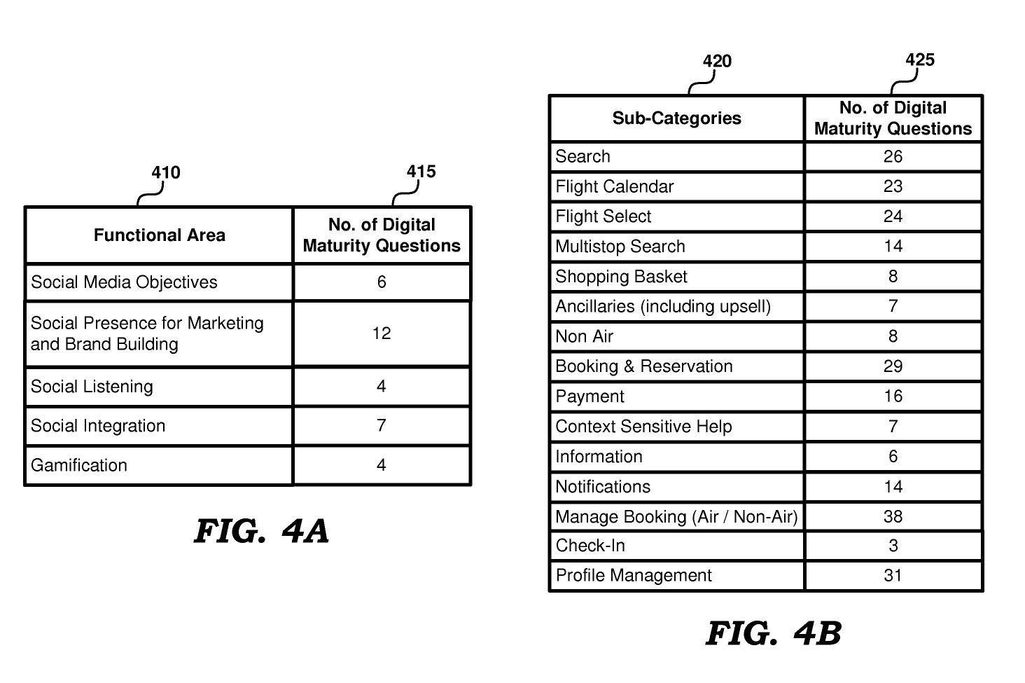

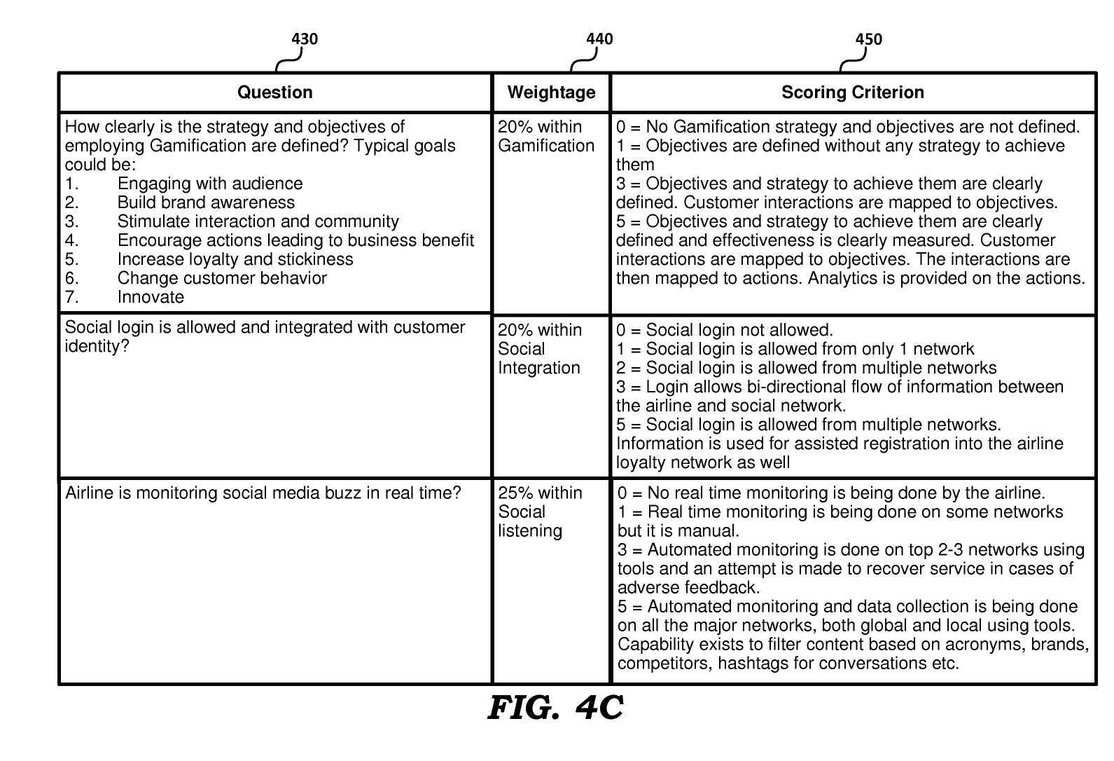

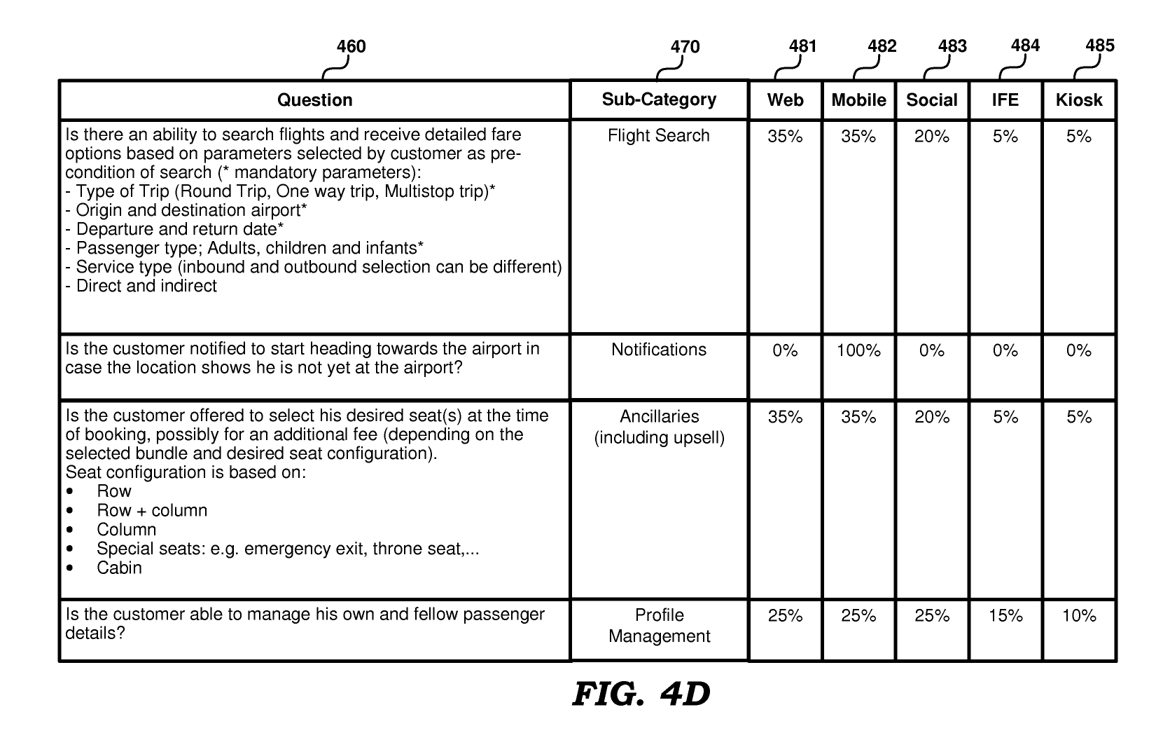

FIGS. 4A-4D illustrates the manner in which availability of engagement capabilities of digital channels is assessed in one embodiment. Broadly, FIGS. 4A and 4C depict details of the questionnaire for Social Media & Gamification 340, while FIGS. 4B and 4D depict details of the questionnaire for Channel Maturity 310. Each of the Figures is described below.

FIGS. 4A and 4C respectively depict a summary and sample set of questions of the questionnaire for Social Media & Gamification 340 in an embodiment. Referring to FIG. 4A, column 410 indicates the various functional areas in Social Media & Gamification 340, with column 415 indicating the corresponding number of questions in the questionnaire for each functional area. Referring to FIG. 4C, column 430 specifies the questions, column 440 specifies the weightages for each question in relation to one or more functional areas and column 450 specifies the scoring criterion. It may be appreciated that that the same question may affect different functional areas, and accordingly the number of questions (in the questionnaire) may be less than the sum of the numbers indicated in column 415.

In an embodiment, the answer to each question (of FIG. 4C) in the questionnaire is in the form of a corresponding value (for example, a number between 1 and 5), and as such the score for a functional area is computed as a weighted sum of the values specified for each of questions in the questionnaire. For example, if there are three questions Q1, Q2 and Q3 in the questionnaire which have a weightage of w1, w2 and w3 respectively towards a functional area (of the assessment vertical), the score for the functional area is computed as AQ1*w1+AQ2*w2+AQ3*w3, where AQ1, AQ2 and AQ3 are the answer values for questions Q1, Q2 and Q3 respectively, and “*” is the multiplication operator.

It may be observed that each of the questions in FIG. 4C is designed to check the availability of a corresponding set of engagement capabilities. The value associated with each of the set of engagement capabilities for a question is indicated in column 450. In response to a question, one of the values indicating the availability of the specific engagement capability is received as the answer and used in the computation of the score as described above.

In one embodiment, each functional area of an assessment vertical is related to a corresponding digital channel, with the assessment vertical being assessed based on a set of sub-categories. Each sub-category represents a corresponding engagement capability that is provided on one or more of the digital channels, and accordingly a score for the sub-category is computed based on the availability of the corresponding engagement capability across the different digital channels. At the same time, the score for a functional area (that is a corresponding digital channel) is also computed based on the values/answers to all the questions in the questionnaire.

FIGS. 4B and 4D respectively depict a summary and sample set of questions of the questionnaire for Channel Maturity 310 in an embodiment. Referring to FIG. 4B, column 420 specifies the various sub-categories based on which Channel Maturity 310 is assessed using questions, while column 425 specifies the number of questions in the questionnaire that are directed to the corresponding sub-category. Referring to FIG. 4D, column 460 specifies the question, column 470 specifies the sub-category for each of the questions, while columns 481-485 indicate respective weightages towards the various digital channels/functional areas noted in FIG. 3 for Channel Maturity 310.

For such a questionnaire, the answer to each question is a value (between 1 and 5) for each of the digital channels. Accordingly, the score for each question is computed as a weighted sum of the values specified for the different digital channels/functional areas. The scores computed for each question may thereafter be summed to compute the score for a sub-category. For example, assuming for the first question shown in FIG. 4C, the values for Web, Mobile, Social, IFE, and Kiosk channels are 3, 4, 5, 2 and 1 respectively, the score for the first question (and also for the sub-category “Flight Search”) is computed as 0.35*3+0.35*4+0.20*5+0.05*2+0.05*1=3.56, where the weightages 0.35, 0.35, etc. are those specified in columns 481-485 for the first question and “*” is the multiplication operator. It may be appreciated by using the answers/values specified (for multiple questions) for a single digital channel/functional area (for example, column 481) and the corresponding weightages specified in the column, the score for the functional area (online maturity 311) can be computed using the formula noted above with respect to FIG. 4C.

Using the approaches noted above, the scores corresponding to each functional area (such as 341, 342, etc.) of FIG. 3 and also sub-categories (as shown in FIG. 4B) may be computed. The scores may then be provided to the users/personnel of the Airline. For example, the scores may be provided in the form of a printed report. Alternatively, the scores may be displayed as part of a user interface provided on a display unit (not shown) associated with DMA system 150.

In one embodiment, the scores are displayed in the form of one or more radar graphs, each radar graphs corresponding to an assessment vertical (310, 320, etc.). In a radar graph for an assessment vertical (e.g. 340), the functional areas grouped into the assessment vertical (such as 341, 342, 343, etc.) are represented as corresponding axes of the radar graph with the scores for each of the functional areas plotted along the corresponding axes. In a scenario that an assessment vertical is assessed based on sub-categories (such as Channel Maturity 310), the sub-categories are represented as corresponding axes of the radar graph, with the scores for each of the sub-category plotted along the corresponding axes.

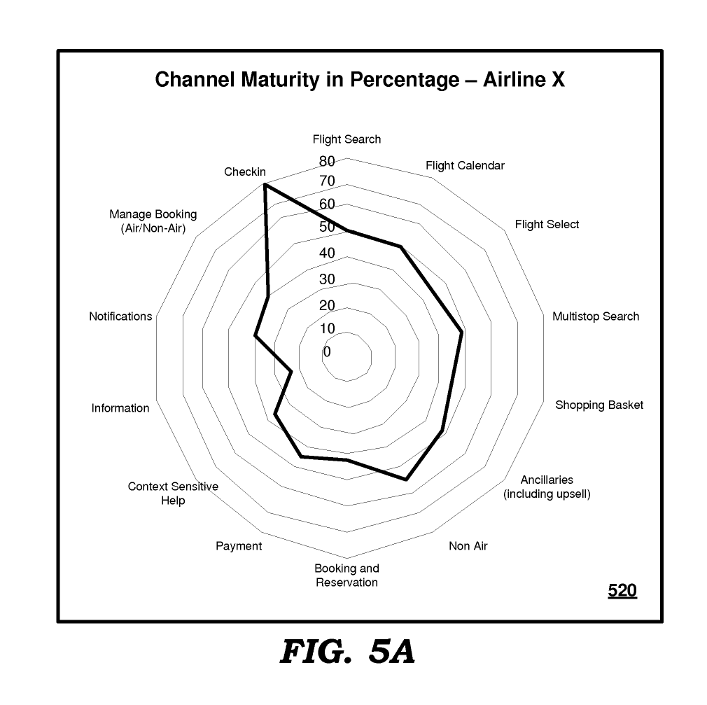

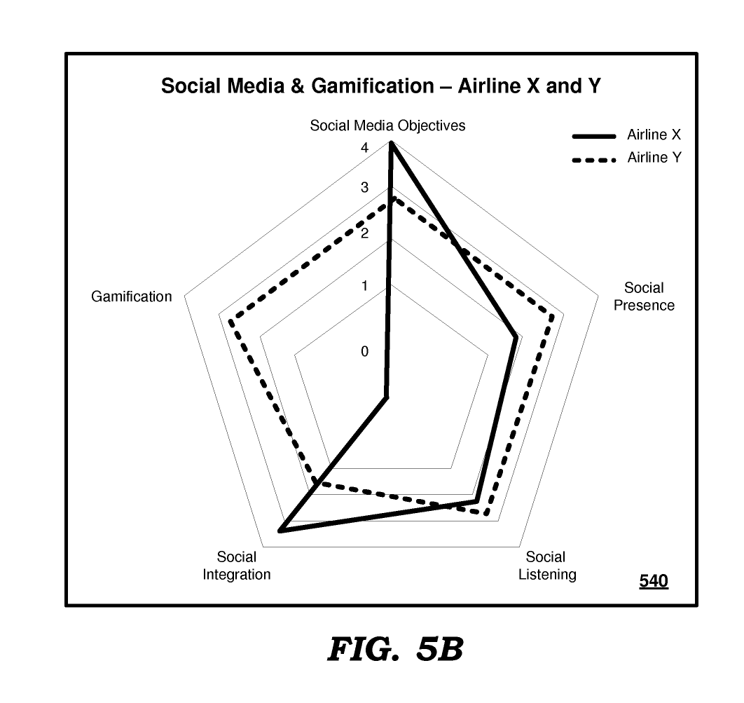

FIGS. 5A and 5B depict the manner in which scores representing digital maturity of a transport provider (airline) is displayed in one embodiment. Display area 520 depicts a radar graph displayed for Channel Maturity 310, while display area 540 depicts a radar graph displayed for Social Media & Gamification 340. The values/scores computed for the Airline is shown in the form of a dark polygon, as is well known with respect to radar graphs.

As may be appreciated, the radar graph of display area 520 indicates that the Airline has a fair amount of digital maturity in all sub-categories, while the radar graph of display area 540 indicates that the Airline does not have any engagement capabilities in relation to Gaming 345 (as indicated by the value 0). Furthermore, in display area 540, the scores obtained for another/competitor airline is also shown as a dashed polygon. The dashed polygon indicates that the competitor airline has good engagement capabilities in the Gaming (345) functional area.

By viewing overlaid radar graphs of other transportation providers/airlines or with pre-defined standards, personnel of the airline can identify the specific functional areas that need to be improved/added to modify customer behavior, save cost and increase revenues based on new industry standards (noted above), and also to generate ancillary revenues.

It should be appreciated that the features described above can be implemented in various embodiments as a desired combination of one or more of hardware, executable modules, and firmware. The description is continued with respect to an embodiment in which various features are operative when executable modules are executed.

### 6. Digital Processing System

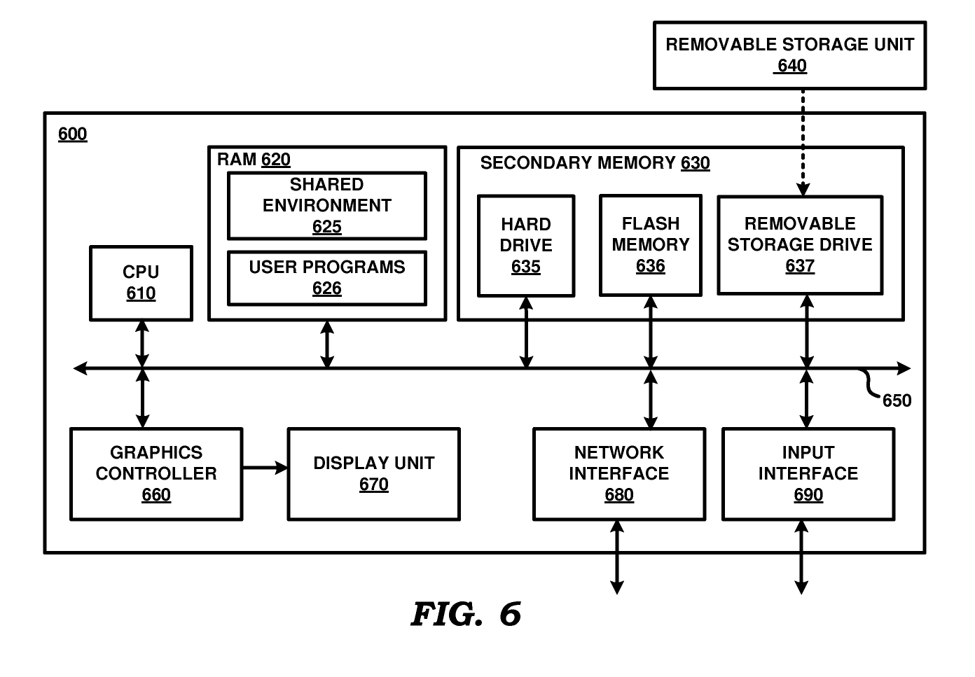

FIG. 6 is a block diagram illustrating the details of digital processing system 600 in which various aspects of the present disclosure are operative by execution of appropriate executable modules. Digital processing system 600 corresponds to digital maturity assessment (DMA) system 150.

Digital processing system 600 may contain one or more processors such as a central processing unit (CPU) 610, random access memory (RAM) 620, secondary memory 630, graphics controller 660, display unit 670, network interface 680, and input interface 690. All the components except display unit 670 may communicate with each other over communication path 650, which may contain several buses as is well known in the relevant arts. The components of FIG. 6 are described below in further detail.

CPU 610 may execute instructions stored in RAM 620 to provide several features of the present disclosure. CPU 610 may contain multiple processing units, with each processing unit potentially being designed for a specific task. Alternatively, CPU 610 may contain only a single general-purpose processing unit.

RAM 620 may receive instructions from secondary memory 630 using communication path 650. RAM 620 is shown currently containing software instructions constituting shared environment 625 and user programs 626. Shared environment 625 includes operating systems, device drivers, virtual machines, etc., which provide a (common) run time environment for execution of user programs 626.

Graphics controller 660 generates display signals (e.g., in RGB format) to display unit 670 based on data/instructions received from CPU 610. Display unit 670 contains a display screen to display the images (such as the portions of the user interfaces shown in FIGS. 5A-5B) defined by the display signals. Input interface 690 may correspond to a keyboard and a pointing device (e.g., touch-pad, mouse) and may be used to provide appropriate inputs. Network interface 680 provides connectivity to a network (e.g., using Internet Protocol), and may be used to communicate with other systems (of FIG. 1) connected to the network (110).

Secondary memory 630 may contain hard drive 635, flash memory 636, and removable storage drive 637. Secondary memory 630 may store the data (for example, portions of the data shown in FIGS. 4A-4D, computed scores shown in FIGS. 5A-5B) and software instructions (for implementing the flowchart of FIG. 2), which enable digital processing system 600 to provide several features in accordance with the present disclosure. The code/instructions stored in secondary memory 630 may either be copied to RAM 620 prior to execution by CPU 610 for higher execution speeds, or may be directly executed by CPU 610.

Some or all of the data and instructions may be provided on removable storage unit 640, and the data and instructions may be read and provided by removable storage drive 637 to CPU 610. Removable storage unit 640 may be implemented using medium and storage format compatible with removable storage drive 637 such that removable storage drive 637 can read the data and instructions. Thus, removable storage unit 640 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 640 or hard disk installed in hard drive 635. These computer program products are means for providing software to digital processing system 600. CPU 610 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 630. Volatile media includes dynamic memory, such as RAM 620. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 650. Transmission media can also take the form of acoustic or light waves, such as those generated during radio-wave and infra-red data communications.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

While various embodiments of the present disclosure have been described above, it should be understood that they have been presented by way of example only, and not limitation. Thus, the breadth and scope of the present disclosure should not be limited by any of the above-described exemplary embodiments, but should be defined only in accordance with the following claims and their equivalents.

It should be understood that the figures and/or screen shots illustrated in the attachments highlighting the functionality and advantages of the present disclosure are presented for example purposes only. The present disclosure is sufficiently flexible and configurable, such that it may be utilized in ways other than that shown in the accompanying figures.

What is claimed is:

1. A method of assessing digital maturity of a transport provider, said method comprising:
receiving data indicating availability of each of a plurality of engagement capabilities on respective ones of a plurality of digital channels of said transport provider; and
computing a plurality of scores representing digital maturity of said transport provider based on said availability.

2. The method of claim 1, wherein said plurality of engagement capabilities are categorized according to a plurality of functional areas qualifying an industry of said transport provider,
wherein each of said plurality of scores corresponds to a respective functional area of said plurality of functional areas.

3. The method of claim 2, wherein said plurality of functional areas are further grouped into a plurality of assessment verticals, said method further comprising:
providing a respective questionnaire for each of said plurality of assessment verticals, wherein a questionnaire for an assessment vertical contains questions directed to determining the availability of the engagement capabilities in the functional areas grouped into the assessment vertical,
wherein said data comprises answers to questions in each of said plurality of questionnaires.

4. The method of claim 3, further comprising displaying a respective radar graph for each of said plurality of assessment verticals,
wherein the functional areas grouped into an assessment vertical are represented as corresponding axes of the radar graph for the assessment vertical with the scores for each of the functional areas plotted along the corresponding axes.

5. The method of claim 4, wherein said industry comprises airline industry, and said plurality of assessment verticals comprise channel maturity, merchandize, personalized interaction, social media & gamification, channel compatibility, and distribution.

6. The method of claim 3, wherein a first questionnaire for a first assessment vertical of said plurality of assessment verticals contains a first set of questions, wherein the answer to each of said first set of questions is a corresponding value,
wherein each question of said first set of questions contributes a corresponding weight to a first functional area of a first set of functional areas grouped into said first assessment vertical,
wherein a score for said first functional area is computed as a weighted sum of the values specified for each of said first set of questions.

7. The method of claim 6, wherein each of said first set of functional areas is related to a corresponding one of said plurality of digital channels,
wherein said first assessment vertical is assessed based on a first set of sub-categories, each sub-category representing a corresponding engagement capability that is provided on one or more of said plurality of digital channels,
wherein said computing computes scores for each functional area of said first set of functional areas and for each sub-category of said first set of sub-categories.

8. A non-transitory machine readable medium storing one or more sequences of instructions for causing a system to assess digital maturity of a transport provider, wherein execution of said one or more instructions by one or more processors contained in said system causes said system to perform the actions of:
receiving data indicating availability of each of a plurality of engagement capabilities on respective ones of a plurality of digital channels of said transport provider; and
computing a plurality of scores representing digital maturity of said transport provider based on said availability.

9. The non-transitory machine readable medium of claim 8, wherein said plurality of engagement capabilities are categorized according to a plurality of functional areas qualifying an industry of said transport provider,
wherein each of said plurality of scores corresponds to a respective functional area of said plurality of functional areas.

10. The non-transitory machine readable medium of claim 9, wherein said plurality of functional areas are further grouped into a plurality of assessment verticals, further comprising one or more instructions for:
providing a respective questionnaire for each of said plurality of assessment verticals, wherein a questionnaire for an assessment vertical contains questions directed to determining the availability of the engagement capabilities in the functional areas grouped into the assessment vertical,
wherein said data comprises answers to questions in each of said plurality of questionnaires.

11. The non-transitory machine readable medium of claim 10, further comprising one or more instructions for displaying a respective radar graph for each of said plurality of assessment verticals,
wherein the functional areas grouped into an assessment vertical are represented as corresponding axes of the radar graph for the assessment vertical with the scores for each of the functional areas plotted along the corresponding axes.

12. The non-transitory machine readable medium of claim 11, wherein said industry comprises airline industry, and said plurality of assessment verticals comprise channel maturity, merchandize, personalized interaction, social media & gamification, channel compatibility, and distribution.

13. The non-transitory machine readable medium of claim 10, wherein a first questionnaire for a first assessment vertical of said plurality of assessment verticals contains a first set of questions, wherein the answer to each of said first set of questions is a corresponding value,
wherein each question of said first set of questions contributes a corresponding weight to a first functional area of a first set of functional areas grouped into said first assessment vertical,
wherein a score for said first functional area is computed as a weighted sum of the values specified for each of said first set of questions.

14. The non-transitory machine readable medium of claim 13, wherein each of said first set of functional areas is related to a corresponding one of said plurality of digital channels,
wherein said first assessment vertical is assessed based on a first set of sub-categories, each sub-category representing a corresponding engagement capability that is provided on one or more of said plurality of digital channels,
wherein said computing computes scores for each functional area of said first set of functional areas and for each sub-category of said first set of sub-categories.

15. A digital processing system comprising:
a processor;
a random access memory (RAM);
a machine readable medium to store one or more instructions, which when retrieved into said RAM and executed by said processor causes said digital processing system to assess digital maturity of a transport provider, said digital processing system performing the actions of:
receiving data indicating availability of each of a plurality of engagement capabilities on respective ones of a plurality of digital channels of said transport provider; and
computing a plurality of scores representing digital maturity of said transport provider based on said availability.

16. The digital processing system of claim 15, wherein said plurality of engagement capabilities are categorized according to a plurality of functional areas qualifying an industry of said transport provider,
wherein each of said plurality of scores corresponds to a respective functional area of said plurality of functional areas.

17. The digital processing system of claim 16, wherein said plurality of functional areas are further grouped into a plurality of assessment verticals, said digital processing system further performing the actions of:
providing a respective questionnaire for each of said plurality of assessment verticals, wherein a questionnaire for an assessment vertical contains questions directed to determining the availability of the engagement capabilities in the functional areas grouped into the assessment vertical,
wherein said data comprises answers to questions in each of said plurality of questionnaires.

18. The digital processing system of claim 17, further performing the actions of displaying a respective radar graph for each of said plurality of assessment verticals,
wherein the functional areas grouped into an assessment vertical are represented as corresponding axes of the radar graph for the assessment vertical with the scores for each of the functional areas plotted along the corresponding axes.

19. The digital processing system of claim 18, wherein said industry comprises airline industry, and said plurality of assessment verticals comprise channel maturity, merchandize, personalized interaction, social media & gamification, channel compatibility, and distribution.

20. The digital processing system of claim 17, wherein a first questionnaire for a first assessment vertical of said plurality of assessment verticals contains a first set of questions, wherein the answer to each of said first set of questions is a corresponding value,
wherein each question of said first set of questions contributes a corresponding weight to a first functional area of a first set of functional areas grouped into said first assessment vertical,
wherein a score for said first functional area is computed as a weighted sum of the values specified for each of said first set of questions.
